(19) United States
(12) Patent Application Publication
(10) Pub. No.: US 2009/0070300 A1
(43) Pub. Date: Mar. 12, 2009

(54) Method for Processing Data Queries

(75) Inventors: Christian Bartels, Dossenheim (DE); Eric Kass, Mannheim (DE); Dorothea Rink, Sinsheim (DE)

Correspondence Address: DUKE W. YEE;YEE & ASSOCIATES, P.C., P.O. BOX 802333, DALLAS, TX, 75380, US

(73) Assignees: International Business Machines Corporation, Armonk, NY (US); SAP AG, Walldorf (DE)

(21) Appl. No.: 12/205,508

(22) Filed: Sep. 5, 2008

(30) Foreign Application Priority Data
Sep. 7, 2007 (EP) 07115926.3

(51) Int. Cl. G06F 7/06; G06F 17/30

(52) U.S. Cl. 707/3; 707/E17.014

(57) ABSTRACT

Data queries can be processed in the following way without changing any existing program logic or application code. Control information for determining access plan instructions for data queries is accessed. A first data query for extracting information from a data source is received. Access plan instructions for the first data query are determined based at least on contents of the first data query and the control information. Access plan instructions are provided to the data source for generating an access plan to extract the information.

### BACKGROUND

1. Field of the invention

The invention relates to a method for processing data queries.

2. Related art

The generic relational database management system (DBMS) typically offers a natural language query interface to retrieve information from one or many tables at a time. In most cases, the language is Structured Query Language (SQL). An example of a simple SQL query is “SELECT AVERAGE (SALARY) FROM EMPLOYEES”. Queries into a DBMS can be quite complex; especially when multiple logically inter-related tables are involved in the predicate selection, ordering, grouping, or in the analytical expressions that form the returned results. A programmer or end-user may write queries manually, but often queries are generated automatically from conceptually higher-level requests. An example of such a request for a sales and distribution system would be to determine, for a given timeframe and geography, which sales representatives generated twice as much revenue as the average other. Very large queries are sometimes generated as a result of a seemingly simple operation in a graphical user interface, for example, a spreadsheet showing product category vs. sales grouped by region and season.

To satisfy a query, the DBMS typically parses the query statement. By parsing is meant the process of analyzing the tokens that constitute the query statement to determine their grammatical structure with respect to the formal grammar defined by the query language. Based on this syntactic analysis, the DBMS typically builds an access plan. By an access plan is meant a set of steps used to access the information contained in the DBMS. In the case of a relational DBMS, the access plan is sometimes referred to as a query plan or query execution plan. Many valid access plans which would return the same valid result may conceivably exist; however different access plans may require varying system resources like memory or execution time. The DBMS may also not be able to derive an optimum access plan in an acceptable amount of time based solely on the provided query statement.

To assist the DBMS in generating optimized access plans, some DMBSs have introduced the concept of SQL hints. By an SQL hint is meant additional information passed along with the query to help the DBMS select a favorable plan. An implementation of SQL hints for an Oracle database is described in the prior art “Oracle Database Performance Tuning Guide”, available through the World Wide Web at http://www.stanford.edu/dept/itss/docs/oracle/10g/server.101/b10 752/hintsref.htm. For example, an SQL hint may suggest a join order indicating from which table data should first be retrieved, which may be used if the application writer has a-priori knowledge that the resulting number of rows from one table is small. A disadvantage of using SQL hints lies in the requirement on the application writer of modifying application code, typically by appending a static set of SQL hints to database query statements. Especially when using pre-packaged applications or applications depending on specific middleware components, it is however not always possible to add SQL hints to database query statements.

Many DBMS also offer configuration parameters to influence the specifics of access plan generation. Parameter changes may be applied at runtime but require program or DBMS administrator intervention. A specific set of configuration parameters may be selected for a particular DBMS connection, providing a means for the DBMS administrator to select which applications operate under which set of parameters.

### SUMMARY OF THE INVENTION

A first aspect of the invention provides a computerized method for processing data queries, comprising the steps of
accessing control information for determining access plan instructions for data queries;
receiving a first data query for extracting information from a data source;
determining access plan instructions for the first data query based at least on contents of the first data query and the control information; and
providing the access plan instructions to the data source for generating an access plan to extract the information.

A method according to the invention may comprise the steps of
determining status information on the data source; and
using the status information in determining the access plan instructions.

The method may further comprise the steps of
receiving the first data query from an application;
determining information describing the application; and
using the information in determining the access plan instructions.

Furthermore, the method may comprise the steps of
retrieving further access plan instructions from a history of previously determined access plan instructions and
using the further access plan instructions in determining the access plan instructions.

The control information may comprise at least a predicate for determining a Boolean value and an access plan instruction to be added to the first data query based at least on the Boolean value. The predicate may comprise at least one of the following:
a Boolean expression;
an expression based on fuzzy logic; and
a function defined by an artificial neural network.

As another option, the method may comprise providing the access plan instructions to the data source using a control signal of the data source. It may also comprise adding the access plan instructions to the first data query, resulting in a second data query for generating the access plan.

As another option, a method according to the invention may comprise the steps of:
monitoring an execution of the second data query; and
based on the execution, modifying the control information.

The first data query and the second data query may be SQL queries and the access plan instructions may comprise an SQL hint.

A second aspect of the invention provides a computer program product comprising a computer useable medium having a computer readable program, wherein the computer readable program when executed on a computer causes the computer to:
access control information for determining access plan instructions for data queries;
receive a first data query for extracting information from a data source;
determine access plan instructions for the first data query based at least on contents of the first data query and the control information; and
provide the access plan instructions to the data source for generating an access plan to extract the information.

The computer readable program may comprise a database driver and when executed on a computer cause the computer to:
receive the first data query from an application and
send the second data query to the data source.

As another option, the computer readable program may be a subprogram for linking into an application.

A third aspect of the invention provides a device for processing database queries, comprising
storage for storing control information for determining access plan instructions for data queries;
an access plan instruction generator for determining access plan instructions for a received first data query for extracting information from a data source, the access plan instruction generator being responsive at least to contents of the first data query and the control information; and
an access plan instruction provider for providing the access plan instructions to the data source for generating an access plan to extract the information, the access plan instruction provider responsive to the access plan instruction generator.

### BRIEF DESCRIPTION OF THE DRAWINGS

For a better understanding of the present invention and as how the same may be carried into effect, reference will now be made by way of example only to the accompanying drawings in which:

FIG. 1 shows, as an example, a flowchart of a process according to an embodiment of the invention.

FIG. 2a shows, as an example, a block diagram of the components of a system or device according to an embodiment of the invention.

FIG. 2b shows, as an example, a block diagram of the components of a database driver according to an embodiment of the invention.

FIG. 3a and 3b show two examples of configuration rules for use with a process according to an embodiment of the invention.

FIG. 3c shows the configuration rule syntax according to FIG. 3a and 3b in extended Backus-Naur form.

FIG. 4 shows, as an example, a block diagram of the components of a further system according to an embodiment of the invention.

FIG. 5 shows a system block diagram of a typical computer system used to execute the software according to an embodiment of the present invention.

### DETAILED DESCRIPTION OF THE EMBODIMENTS

The invention that is presented here aims to provide a more flexible scheme of optimizing database access.

Embodiments of the invention are applicable in any computer program that queries into a data source. In the following description, a DBMS is used as an example of a data source and SQL is used as an example of a query language.

The major benefit of the proposed approach is the ability to provide SQL hints for the DBMS optimizer without the need to change any existing program logic or application code. It is a further intent of the invention to provide a reasonable dynamic, ancillary hint mechanism for end users, application programmers, and database administrators.

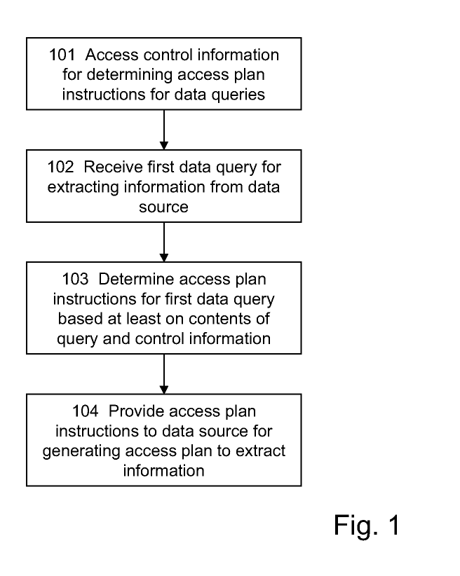

The proposed approach is elucidated by reference to an embodiment in conjunction with FIG. 1.

In step 101, the process of FIG. 1 accesses control information for determining access plan instructions for data queries. This control information may typically comprise a set of configuration rules or other inferential mechanism. An embodiment of the invention may allow the user or administrator to change configuration rules dynamically at application runtime. Such an embodiment may expose a specially defined application programming interface (API) to allow the programmatic modification of configuration rules by an application programmer. An example of a function call to add a configuration rule using such an API is “AddHintCondition(“if Table=‘abc’ & nMarkers>=12 then SingleExecution”);”.

Typically, the configuration rules can be specified in a form that can easily be processed by a computer program. In a preferred embodiment, each configuration rule contains an “IF” clause specifying a predicate for determining a Boolean value. The configuration rule would also contain a “THEN” clause to specify an SQL hint to be applied in case the predicate evaluates to true. As an example, a complete configuration rule may read “IF (statement references MYTABLE and calling application is MYAPP) THEN apply hint ‘OPTIMIZE FOR ALL ROWS’”. Optionally, the configuration rule may contain an “ELSE” clause to specify an SQL hint to be applied in case the predicate evaluates to false.

While in a typical embodiment the predicate would be specified as a Boolean expression, in alternative embodiments it may be based on fuzzy logic or contain a function defined by an artificial neural network (ANN). An example of a configuration rule whose predicate is based on fuzzy logic is “IF statement is complex AND user is important AND query is not irrelevant THEN optimize heavily”.

In step 102, the process receives a first data query for extracting information from a data source. In step 103, the process determines access plan instructions for the first data query based at least on contents of the first data query and the control information provided in step 101. In embodiments where the control information comprises a set of configuration rules, step 103 may include an evaluation of these rules. Typically, the access plan instructions would take the form of SQL hints. In another embodiment, the access plan instructions may take the form of DBMS control signals. These control signals would typically be passed using APIs or other interfaces provided by the DBMS.

In step 104, the process provides the access plan instructions to the data source for generating an access plan to extract the information. Typically, this would be accomplished by adding the access plan instructions to the first data query, resulting in a second data query for generating the access plan. The resulting second data query is typically forwarded to the respective data source. In a preferred embodiment, the forwarded query would then contain SQL hints specifically adapted for use with this particular data source.

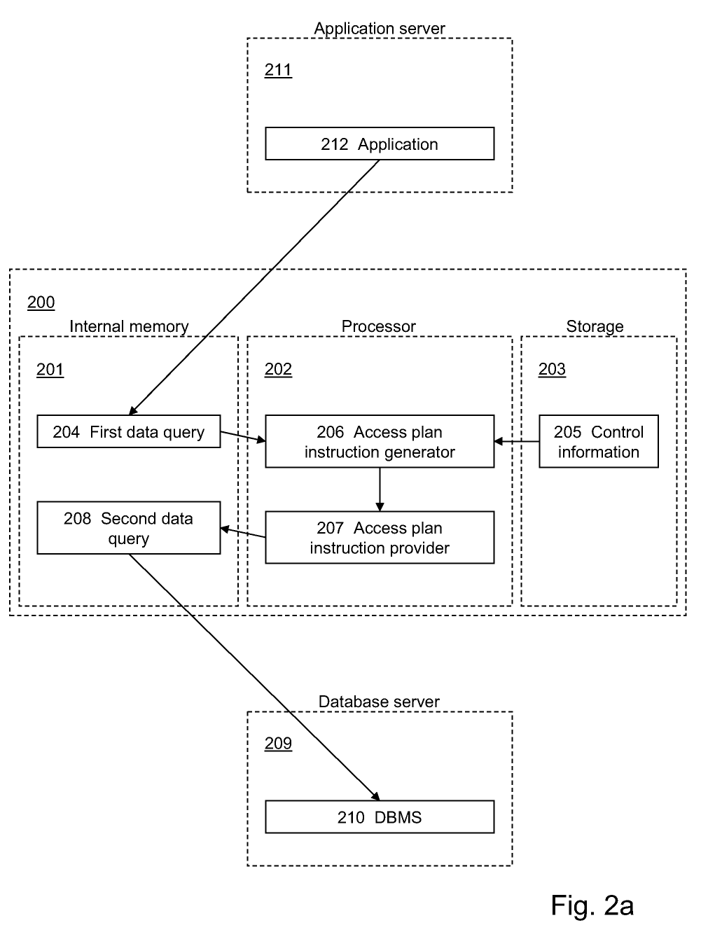

FIG. 2a shows, as an example, a block diagram of the components of a system or device 200 according to an embodiment of the invention. In this example, an application 212 residing on a typically remote application server 211 would send a first data query 204 to the system or device 200. In an alternative embodiment, the first data query 204 may be intercepted by a database driver, which would typically reside locally on the application server 211. Still another embodiment of the invention may take the form of a library. By a library is meant a subprogram or a collection of subprograms that can be referenced by the application 212. In this case, the library may provide an entry point, that is, a method contained within the library, that the application 212 would typically use to pass the data query to the library. An alternative embodiment of the invention takes the form of a library to be referenced by the DBMS 210.

An access plan instruction generator 206, typically executed by a processor 202, is a component that takes as input a first data query 204 and control information 205. The first data query 204 is typically stored for intermediate processing in an internal memory 201, whereas the control information 205 is typically permanently stored in a storage 203 of the system or device 200.

Responding to the access plan instruction generator 206 and typically executed by the same processor 202, a query constructor 207 serves to construct a second data query 208 by adding access plan instructions to the first data query 204 as determined by the access plan instruction generator 206. The second data query 208, like the first data query 204, is typically stored in the internal memory 201 of the system or device 200.

A database server 209, which is typically located remote from the system or device 200, hosts the DBMS 210 that serves as a data source for the second data query 208. Alternatively, the database server 209 may be formed integrally with the system or device 200, in which case the DBMS 210 would typically share the internal memory 201, processor 202, and storage 203 of the system or device 200.

Although FIG. 2a shows that the first and second data queries 204 and 208 are stored in the internal memory 201 of the system or device 200, this is not to be considered mandatory. Each of the first and second data queries 204 and 208 may be stored in any storage means. The storage 203 may be, for example, a hard disk or CD-ROM.

FIG. 2b shows a block diagram of the components of an embodiment of the invention taking the form of a database driver or similar integration component. In this embodiment, the database driver 250 would receive the first data query from the application 212 as depicted by arrow 253, for example, by intercepting query statements sent by application 212 to the DBMS 210. As depicted by arrow 254, driver 250 may additionally analyze, or sense, the environment of application 212, for example, to determine the application name, process user, or mode of operation (for example, batch or interactive mode). A similar environment sensing may be applied to the DBMS 210 (arrow 256), for example, to determine the utilization or time of day of the DBMS 210.

The driver 250 would typically access control information 205. This control information 205 may have been specified interactively by way of a graphical user interface (GUI) 251. The configuration rules may also be read from a configuration file 252, typically residing in a local file system of the application server 211. Based on the control information 205 and taking into account the input from sources 253, 254 and 256, the driver 250 may provide specifically adapted access plan instructions for DBMS 210, typically in the form of SQL hints for appending to the forwarded data query.

The database driver 250 may optionally monitor the data queries forwarded to DBMS 210 to automatically instantiate configuration rules to add to the control information 205. By applying these configuration rules to future data queries to be processed, a feedback loop is effectively implemented. An embodiment supporting this feedback mechanism provides the additional advantage of displaying self-optimizing behavior. As an example, if the driver 250 finds a particular type of data query referencing a specific database table of DBMS 210 to be time consuming, the driver 250 could automatically add a configuration rule causing similar data queries to perform better. Using an API provided by the driver 250, such a rule may be added via a programming language construct of the form “AddHintCondition(“Table=‘xyz’ & Module=‘abc’ ? SingleExecution=true”);”.

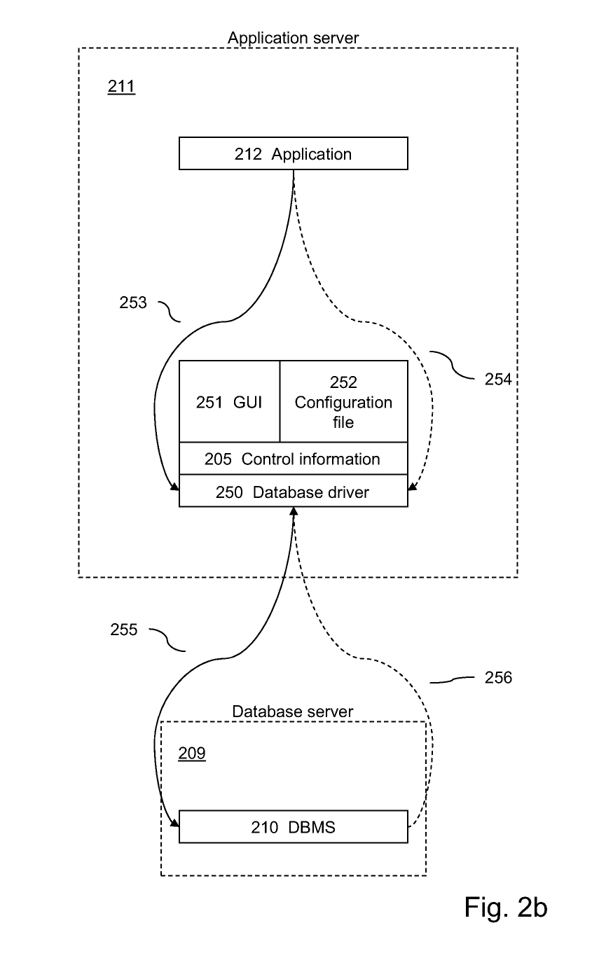

FIG. 3a and FIG. 3b show two examples of configuration rules. The configuration rules 300 and 310 according to FIG. 3a and FIG. 3b are expressed by means of the conditional operators 302 and 312.

The predicates 301 and 311 of the configuration rules 300 and 310 serve as first operands to the operators 302 and 312, respectively, and each evaluate to a Boolean value. The SQL hints 303, 313 and 315 serve as second operands to the operators 302 and 312, respectively. The concatenation operator 314 serves to connect the SQL hints 313 and 315.

Instead of the shorthand operators 302 and 312, an alternative embodiment may use keywords, for example, “IF” and “THEN”, to enclose and thus identify the predicates 301 and 311.

A typical semantic interpretation of configuration rule 300 would be that the SQL hint 303 is to be added to a first data query if and only if the predicate 301 evaluates to the Boolean value “true”. In a corresponding interpretation of configuration rules 310, both the SQL hints 313 and 315 are to be added to a first data query if the predicate 311 evaluates to be “true”.

An SQL hint may also be used in a predicate expression to determine whether that specific hint has been specified statically by the application that sent the respective data query (not depicted).

While the sample configuration rules 300 and 310 require the predicates 301 and 311 to be Boolean expressions, an alternative embodiment may allow the predicate of a configuration rule to comprise an expression based on fuzzy logic as described by L.A. Zadeh in “Outline of a New Approach to the Analysis of Complex Systems and Decision Processes”, IEEE transactions on Systems, Man and Cybernetics (1973). Still another embodiment may allow the use of functions defined by artificial neural networks (ANNs) to constitute a predicate.

FIG. 3c shows the configuration rule syntax employed in FIG. 3a and 3b. FIG. 3c uses the metasyntax defined by the extended Backus-Naur form (EBNF) according to ISO-14977 to express the context-free grammar of the configuration rule language of rules 300 and 310. Examples of variables that may be used in configuration rules are: “Table”; “Module”; “NoSTMTID”; “nMarkers”; and “Operation”. Variables may have conceptually different elements (WHICH, WHEN, HOW); although they appear equivalently within a Boolean expression. A conditional hint may be written as:
if WHICH(Statement) and WHEN(Universe) then HOW
   where:
      WHICH(Statement)—Whether ‘Statement’ is a candidate for hint modification. ‘WHICH’ conditions limit the scope of statements over which a conditional hint applies
      WHEN(Universe)—Whether hints are applicable in this environment. ‘WHEN’ conditions limit the scope in time and place when a conditional hint applies.
      HOW—The resulting ‘modification’; SQL Hint, DBMS control signal.

These variables (WHICH elements) are described in the following.

The “Table” variable matches any database table that is referenced in the SQL statement forming the first data query. In the SQL statement “SELECT Name, Phone FROM Employees, PhoneNumbers WHERE Employees.EmployeeID=PhoneNumbers.EmployeeID”, the “Table” variable would match the “Employees” and “PhoneNumbers” tables. Typically, the wildcard character “*” may be used to substitute for any other character or characters in a table name. As an example, the value “Emp*” may be used to substitute for the table name “Employees”.

For example, in a business intelligence (BI) scenario, it may be known that fact tables have names like ‘Fact-SalesData’. Since fact tables are typically involved in Star-Joins, it may be appropriate to specify a conditional hint like:
Table=‘Fact*’ ? JoinType=‘Star’ & CenterJoinTable=% Table %
   Where:
      Table=‘Fact*’ selects all SQL statements that reference tables whose names begin with ‘Fact’.
      JoinType=‘Star’ tells the DBMS that it should implement a star-join.
      CenterJoinTable=% Table % tells the DBMS which table should be in the center of the star-join (% Table % is replaced by the name of the fact table by the Conditional Hint Engine (e.g. ‘Fact-SalesData’). to help the database optimizer recognize the best plan.

The “Module” variable matches the name of the application or program that sent the first data query. In the example of the SAP ERP system by SAP AG, this may be the name of the business report originating the query. An embodiment of the invention would typically receive this value from the application, query the operating system for process information (loaded modules), or determine the value from a call stack. By call stack is meant the data structure which stores information about the active subroutines of the program.

It may be known, for example, that a particular application or module generates SQL statements “on-the-fly” and it would therefore be highly unlikely that the same statement would be executed twice. Here a Conditional-Hint could be used to tell the Driver and DBMS this fact (‘SingleExecution’) so that caches are not polluted with statements that would not be used twice.

StatementID/“NoSTMID”. StatementID is a variable matching a statement identifier that may be passed down along with the SQL query statement text. StatementID could be a partial specification (i.e. wildcard) to denote a potential class of statements. “NoSTMID” is a Boolean variable taking the value “true” if the first data query does not comprise a statement identifier for referring to a particular SQL statement. “NoSTMID” would take the value “false” if the query does comprise such an identifier.

Whether or not an application passes down a statementID may indicate that the application does or does not intend to use the statement a second time. A statement with an ID may be prepared at one time and used later (potentially multiple times). “nMarkers” is an integer variable representing the number of parameter markers contained in the SQL statement that forms the first data query. By a parameter marker is meant a reference in the SQL statement to a variable in the application that sent the first data query, usually represented by a question mark (“?”). In the example of the SQL statement “SELECT Salaries from EmployeeData WHERE Employee=? AND Location=?”, the variable “nMarkers” would take the value 2.

One may use ‘nMarkers’ as a simple measure of complexity or statement variability. A conditional hint could be used, for example, to move complex queries to a dedicated database host node (working with ‘batch-mode’ priority rather than ‘real-time’).

The variable “Operation”, having a fixed set of allowed values, denotes the type of SQL statement issued by the application. This variable matches the value “Query” for a SELECT statement, “Modify” for an INSERT, UPDATE or DELETE statement, “DDL” for an ALTER, DROP or CREATE statement, “Other” for a COMMIT or ROLLBACK statement, and “Any” for any of the above statements.

Examples of WHEN(Universe) elements that may affect hint application are: ProcessPriority=‘Real-Time’. ProgramType=‘WorldWideWeb Interactive’. Time=‘Evening’. etc.

Examples of optimizer hints (HOW elements) that may be used in configuration rules according to the syntax of FIG. 3c are: “SingleExecution”; “SingleExecutionReuse”; “SingleExecutionCached”; “AlternateINILIB”; “QueryClass”; and “HardClose”. These optimizer hints are different from the SQL hints used today in that their interpretation is specific to an embodiment of the invention. Each of these optimizer hints is described in the following.

The optimizer hint “SingleExecution” indicates to the data source that the data query only needs to be prepared and executed once. Typically, in response to this optimizer hint, the data source may discard resources like database cursors or access plans after the data query has completed processing. Additionally, this optimizer hint may indicate to a database driver according to an embodiment of the invention that the data query does not need to be cached for future reuse.

Similarly, the optimizer hint “SingleExecutionReuse” would indicate to the data source and driver that the data query does not need to be cached, however the corresponding access plan may be retained for future reuse.

The optimizer hint “SingleExecutionCached” would indicate to the data source that the data query does not need to be cached, however allow for short-term caching to take place within the database driver.

The optimizer hint “AlternateINILIB” may instruct the data source to use an alternate query options file for dynamically modifying or overriding the environment in which queries are executed. The query options file sets various attributes used by the database manager forming the data source. In the example of the i5/OS operating system commercially available from IBM Corporation, the query options file may be named “QAQQINI” and contain parameters like a join order, optimization goal, and time limits to be used by the database optimizer.

The optimizer hint “QueryClass” may typically only be used in a predicate expression. For example, consider the configuration rule “QueryClass=HumanResources ? SingleExecution”. Given this rule, processing the SQL statement “SELECT AVG(Salary) FROM Employees—% HINT:QUERYCLASS=HumanResources” would cause an embodiment of the invention to add the SQL hint “SingleExecution” to the SQL statement before forwarding it to the data source.

The optimizer hint “HardClose” may instruct a database optimizer of the data source to re-optimize the access plan each time the respective SQL statement is executed, thus closing the created access plan after each execution.

This is important when the data in a table involved in a query changes often. A newly generated plan my be significantly better than an outdated existing (“open”) one.

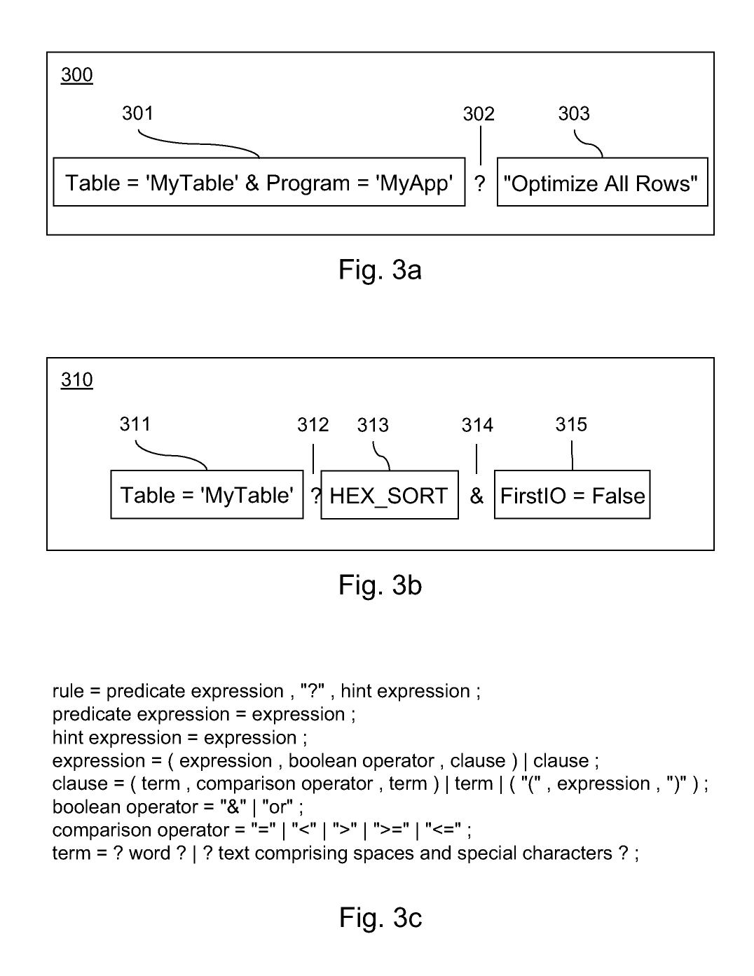

FIG. 4 shows, as an example, a block diagram of the components of a further system according to an embodiment of the invention.

The system according to FIG. 4 considers parameters in determining the access plan instructions that are based on the DBMS and application environment. The optional step of deriving values for these parameters may be referred to as environment sensing. Examples of parameters derived through DBMS environment sensing 401 include the time of day or current utilization of the database server. Examples of parameters derived through application environment sensing 402 include the name of the application originating the request, the process user identifier, and whether the data query was issued in batch or interactive mode.

Intrinsic characteristics 403 of the contents of the first data query 204 to be considered by the system of FIG. 4 in determining the access plan instructions may include the following: table names referenced in the query 204, the statement identifier issued by the originating application, the SQL statement identifier, the complexity of the query 204 (based, for example, on its level of nesting), or the number of parameter markers used in the query 204. The data query 204 may itself already contain SQL hints on which the determination of access plan instructions may be based. Such SQL hints may, for example, include “OPTIMIZE FOR”, “USE INDEX”, or pertain to the optimization level or join order.

The intrinsic characteristics 403 of the data query 204 may also include conditional markers for the purpose of influencing the evaluation of configuration rules in step 405. Interpretation of such a marker would then depend on the control information 205. In a typical embodiment, markers may be required to be enclosed within SQL comment identifiers to separate them from functional parts of the data query 204. An example of an SQL query 204 containing a marker would be “SELECT A FROM B WHERE C>10/* QUERYCLASS=‘Business-Warehouse’ */”, where “/*” and “*/” are comment identifiers delimiting the marker enclosed between them. Here, the control information 205 may define the marker “QUERYCLASS=‘Business-Warehouse’” to cause the addition of a specific set of SQL hints in step 407.

In the embodiment of FIG. 4, the control information 205 comprises a set of configuration rules. An evaluation of these configuration rules 405 would be based on the results of DBMS environment sensing 401, application environment sensing 402, and intrinsic characteristics of the data query 403. This evaluation 406 would typically yield a set or string of SQL hints 406.

Optionally, the system of FIG. 4 may consider SQL hints that were previously computed for other data queries. As an example, consider a sequence of data queries comprising the steps of preparing for the retrieval of data, opening a database cursor, fetching data, and closing the cursor. In this case, an SQL hint that was conditionally added to the data query for preparing retrieval may also need to be added to the data query for closing the cursor. For this case, the embodiment of FIG. 4 comprises a local SQL hint cache 408 to store and recall SQL hints for adding to the first data query 204.

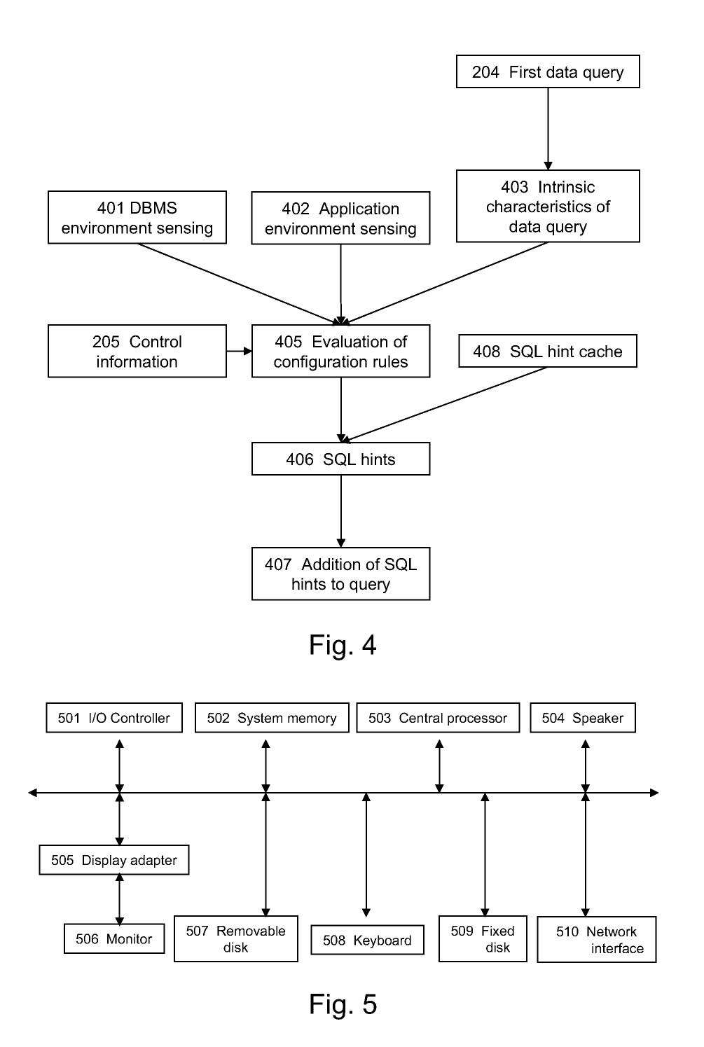

FIG. 5 shows a system block diagram of a typical computer system used to execute the software of an embodiment of the present invention. The computer system according to FIG. 5 may include monitor 506 and keyboard 508. The computer system further includes subsystems such as central processor 503, system memory 502, I/O controller 501, display adapter 505, removable disk 507 (e.g., CD-ROM drive), fixed disk 509, network interface 510, and speaker 504. Other computer systems suitable for use with embodiments of the present invention may include additional or fewer subsystems. For example, another computer system could include more than once processor 503 (i.e., a multi-processor system) or a cache memory.

The invention can take the form of an entirely hardware embodiment, an entirely software embodiment or an embodiment containing both hardware and software elements. In a preferred embodiment, the invention is implemented in software, which includes but is not limited to firmware, resident software, microcode, etc.

Furthermore, the invention can take the form of a computer program product accessible from a computer-usable or computer-readable medium providing program code for use by or in connection with a computer or any instruction execution system. For the purposes of this description, a computer-usable or computer readable medium can be any apparatus that can contain, store, communicate, propagate, or transport the program for use by or in connection with the instruction execution system, apparatus, or device.

The medium can be an electronic, magnetic, optical, electromagnetic, infrared, or semiconductor system (or apparatus or device) or a propagation medium. Examples of a computer-readable medium include a semiconductor or solid state memory, magnetic tape, a removable computer diskette, a random access memory (RAM), a read-only memory (ROM), a rigid magnetic disk and an optical disk. Current examples of optical disks include compact disk-read only memory (CD-ROM), compact disk-read/write (CD-R/W) and DVD.

A data processing system suitable for storing and/or executing program code will include at least one processor coupled directly or indirectly to memory elements through a system bus. The memory elements can include local memory employed during actual execution of the program code, bulk storage, and cache memories which provide temporary storage of at least some program code in order to reduce the number of times code must be retrieved from bulk storage during execution.

Input/output or I/O devices (including but not limited to keyboards, displays, pointing devices, etc.) can be coupled to the system either directly or through intervening I/O controllers.

Network adapters may also be coupled to the system to enable the data processing system to become coupled to other data processing systems or remote printers or storage devices through intervening private or public networks. Modems, cable modem and Ethernet cards are just a few of the currently available types of network adapters.

It is appreciated that although embodiments of the invention have been discussed on the assumption that SQL is used as a query language, this is not to be considered mandatory. It is possible to apply the same process to any query or data manipulation language such as Enterprise Java Bean Query Language/Java Persistence Query Language (EJB-QL), Object Query Language, or non-relational query languages.

It is appreciated that although embodiments of the invention have been discussed on the assumption that a DBMS is used as a data source, this is not to be considered mandatory. It is possible to apply the same process to a variety of data sources such as enterprise resource planning systems, storage servers, or file systems.

This description explicitly describes some combinations of the various features discussed herein. It is appreciated that various other combinations are evident to a skilled person studying this description.

While the foregoing has been with reference to particular embodiments of the invention, it will be appreciated by those skilled in the art that changes in these embodiments may be made without departing from the principles of the invention, the scope of which is defined by the appended claims.

1. A computerized method for processing data queries, comprising the steps of:
accessing control information for determining access plan instructions for data queries;
receiving a first data query for extracting information from a data source;
determining access plan instructions for said first data query based at least on contents of said first data query and said control information; and
providing said access plan instructions to said data source for generating an access plan to extract said information.

2. The method according to claim 1, further comprising the steps of:
determining status information on said data source; and
using said status information in determining said access plan instructions.

3. The method according to claim 1, further comprising the steps of:
receiving said first data query from an application;
determining information describing said application; and
using said information in determining said access plan instructions.

4. The method according to claim 1, further comprising the steps of:
retrieving further access plan instructions from a history of previously determined access plan instructions and
using said further access plan instructions in determining said access plan instructions.

5. The method according to claim 1, wherein said control information comprises at least a predicate for determining a Boolean value and an access plan instruction to be added to said first data query based at least on said Boolean value.

6. The method according to claim 5, wherein said predicate comprises at least one of the following:
a Boolean expression;
an expression based on fuzzy logic; and
a function defined by an artificial neural network.

7. The method according to claim 1, further comprising providing said access plan instructions to said data source using a control signal of said data source.

8. The method according to claim 1, further comprising adding said access plan instructions to said first data query, resulting in a second data query for generating said access plan.

9. The method according to claim 8, further comprising the steps of:
monitoring an execution of said second data query; and
based on said execution, modifying said control information.

10. The method according to claim 8, wherein said first data query and said second data query are SQL queries and said access plan instructions comprise an SQL hint.

11. A computer program product comprising a computer useable medium having a computer readable program, wherein said computer readable program when executed on a computer causes the computer to:
access control information for determining access plan instructions for data queries;
receive a first data query for extracting information from a data source;
determine access plan instructions for said first data query based at least on contents of said first data query and said control information; and
provide said access plan instructions to said data source for generating an access plan to extract said information.

12. The computer program product according to claim 11, wherein said computer readable program comprises a database driver and when executed on a computer causes the computer to:
receive said first data query from an application and
send said second data query to said data source.

13. The computer program product according to claim 11, wherein said computer readable program is a subprogram for linking into an application.

14. A device for processing database queries, comprising:
storage for storing control information for determining access plan instructions for data queries;
an access plan instruction generator for determining access plan instructions for a received first data query for extracting information from a data source, said access plan instruction generator being responsive at least to contents of said first data query and said control information; and
an access plan instruction provider for providing said access plan instructions to said data source for generating an access plan to extract said information, said access plan instruction provider responsive to said access plan instruction generator.
